(19) United States
(12) Patent Application Publication
(10) Pub. No.: US 2002/0182936 A1
(43) Pub. Date: Dec. 5, 2002

(54) Multi-outlet adapter with safety cover

(76) Inventor: Ian Fowler, Chicago, IL (US)

Correspondence Address: SAUL EWING LLP, CENTRE SQUARE WEST, 1500 MARKET STREET, 38TH FLOOR, PHILADELPHIA, PA, 19102-2186, US

(21) Appl. No.: 09/873,972

(22) Filed: Jun. 4, 2001

(51) Int. Cl. H01R 25/00

(52) U.S. Cl. 439/652

(57) ABSTRACT

The present invention discloses a four receptacle multi-outlet adapter having a horizontally swinging door capable of concealing the receptacles while in use. The adapter includes two fixed lower receptacles and two rotatably mounted upper receptacles allowing accessory plug connection respecting the close proximity of the lower receptacles. The two individual lower receptacles include a tapered edge therebetween having a lip to organize and secure the cords of accessory plugs connected to the upper receptacles. The convex contour of the door and receptacle housings, together with the rotatable configuration of the upper receptacles, provide a four receptacle device having a sleek, compact design easily mounted on any standard wall outlet while further providing a safety cover with child-proof locking assembly serving to conceal the receptacles while in use. A three receptacle adapter with vertically swinging door is also provided.

### FIELD OF THE INVENTION

The present invention relates generally to a electrical outlets, and more particularly to a multi-outlet adapter having a safety cover.

BACKGROUND OF THE INVENTION

In the fields of electrical outlet covers and multi-outlet adapters, there is a need for a combination, one-piece multi-outlet adapter with safety cover capable of concealing three or more receptacles while accessory plugs are connected thereto. There is also a need for this multi-outlet adapter with safety cover to have an efficient design, providing child-proof features with ease of use and simple installation on any wall outlet.

Many outlet covers have been developed to mount on a standard wall outlet. Information relevant to attempts to address electrical outlet covers can be found in U.S. Pat. No. 5,989,052; U.S. Pat. No. 5,934,919; U.S. Pat. No. 5,932,845; U.S. Pat. No. 5,912,432; U.S. Pat. No. 5,675,126; U.S. Pat. No. 5,556,289; U.S. Pat. No. 5,288,945; U.S. Pat. No. 5,257,946; U.S. Pat. No. 4,743,206; U.S. Pat. No. 4,737,599; U.S. Pat. No. 4,613,728; U.S. Pat. No. 4,508,933; U.S. Pat. No. Des. 418,114; and U.S. Pat. No. Des. 342,235.

Many multi-outlet adapters also exist, most designed to convert a standard wall outlet into four or six usable receptacles. Information relevant to attempts to address multi-outlet adapters can be found in U.S. Pat. No. Des. 366,453; U.S. Pat. No. Des. 370,460; U.S. Pat. No. Des. 318,849; and U.S. Pat. No. Des. 370,459.

While all of the aforementioned devices fulfill their respective objectives, each suffer from one or more disadvantages. Most outlet covers are limited to preventing wall outlet access while the wall outlet is not in use. Many outlet covers are cumbersome, difficult to install and/or require intricate operation due to multiple pieces susceptible to misplacement when apart. Other outlet covers fail to additionally assist against the inadvertent removal of connected accessory plugs.

Existing multi-outlet adapters also suffer from the disadvantages mentioned above. These adapters additionally fail to offer a safety cover capable of concealing the receptacles while in use (i.e., with accessory plugs connected thereto). For the foregoing reasons, there is a need for a multi-outlet adapter with safety cover provided in a one-piece, compact device adaptable to any wall outlet and capable of concealing the multiple receptacles while in use.

### SUMMARY OF THE INVENTION

The present invention satisfies the need for a multi-outlet adapter with safety cover adaptable to any wall outlet and capable of concealing the multiple receptacles whether idle or in use. In one embodiment of the present invention, a four receptacle multi-outlet adapter satisfies this need by including two fixed lower receptacles with two rotatably mounted upper receptacles. It is the novel arrangement and operability of the four receptacles in the present invention which allows accessory plug connection respecting the close proximity of the upper receptacles to the lower receptacles. It is the close proximity of the upper receptacles to the lower receptacles, along with uniquely contoured door and receptacle housings which allows the four receptacle embodiment of the present invention to be efficiently and compactly housed in a one-piece device providing adaptability to any wall outlet.

In a second embodiment of the present invention, a three receptacle multi-outlet adapter is provided which also includes novel design and receptacle arrangement to similarly satisfy the need mentioned above.

It is therefore one object of the present invention to provide a multi-outlet adapter with safety cover adaptable to any wall outlet and capable of concealing the multiple receptacles while in use.

It is a second object of the present invention to provide a multi-outlet adapter with safety cover adaptable to any wall outlet and capable of concealing the multiple receptacles while in use while minimizing the overall dimensions (volume) of the adapter.

It is another object of the present invention to provide a multi-outlet adapter which is child resistant, assisting the prevention of electrical shock risks associated with standard wall outlets.

It is still another object of the present invention to provide a multi-outlet adapter assisting against inadvertent removal of connected accessory plugs.

A further object of the present invention is to provide an aesthetically pleasing, compact multi-outlet adapter, mountable on any standard wall outlet, with a safety cover which not only conceals the receptacles while in use but further has an exterior surface capable of accepting a customized, user applied finish and/or providing a luminous portion, allowing the device to additionally function as a night light.

A still further object of the present invention is to provide all of the above advantages in a one-piece device providing easy installation, simple operation, low cost of manufacture and economical availability to the public.

In its simplest aspect, the multi-outlet adapter of the present invention comprises a back plate adaptable to a wall outlet for mounting the device on and electrically connecting the device to the wall outlet, at least one receptacle connected to the back plate and a cover connected to the back plate being movable between an open position exposing the at least one receptacle and a closed position concealing the at least one receptacle whether or not the at least one receptacle is in use. The safety cover can be a slidably or hingedly connected to the back plate.

In another aspect of the present invention, the multi-outlet adapter includes a childproof locking assembly. The child-proof locking assembly could include a button flexibly attached to the back plate and a hole in the safety cover aligned to receive the button upon closing of the safety cover, whereby reception of the button by the hole in the safety cover prevents an inadvertent reopening of the door, especially by children.

In still another aspect of the present invention, the cover of the multi-outlet adapter includes an opening defined by an indentation to secure cords of accessories connected to the one or more receptacles. The cover or the back plate could further include clips to organize and secure cords of plugs connected to the one or more receptacles.

In yet another aspect of the present invention, the safety cover of the multi-outlet adapter includes a paintable exterior surface allowing a user to apply a customized finish to the device. The exterior surface of the cover could include a luminous portion, allowing the device to additionally function as a night light.

In a further aspect of the present invention, the multi-outlet adapter includes at least one receptacle fixedly connected to the back plate having prong openings perpendicularly aligned in relation to prong openings of the wall outlet, the perpendicular alignment minimizing a distance the cover extends from the back plate when closed while allowing use of the at least one receptacle while the cover is closed.

In a still further aspect of the present invention, the multi-outlet adapter includes at least one receptacle pivotally connected to the back plate, the pivotal connection allowing insertion of an electrical plug into the at least one pivotal receptacle respective of a close proximity of the at least one pivotal receptacle to other components of the adapter, the pivotal connection minimizing the three dimensional size of the adapter while allowing use of the at least one pivotal receptacle while the cover is closed.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 illustrates a perspective view of a multi-outlet adapter with safety cover having four receptacles and a horizontally swinging door shown in an open position, according to one embodiment of the present invention;

FIG. 2 illustrates a front view of the multi-outlet adapter shown in FIG. 1 with the door cut-away;

FIG. 3 illustrates a back view of the multi-outlet adapter shown in FIG. 1 with the door in a closed position;

FIG. 4 illustrates a side, sectional view of the multi-outlet adapter shown in FIG. 1 taken substantially along line 4-4 of FIG. 2;

FIG. 5 illustrates a left side view of the multi-outlet adapter shown in FIG. 1;

FIG. 6 illustrates a sectional view of upper receptacles of the multi-outlet adapter shown in FIG. 1 taken substantially along line 6-6 of FIG. 2;

FIG. 7 illustrates a sectional view of lower receptacles of the multi-outlet adapter shown in FIG. 1 taken substantially along line 7-7 of FIG. 2;

FIG. 8 illustrates a sectional view of a hinge of the multi-outlet adapter shown in FIG. 1 taken substantially along line 8-8 of FIG. 2;

FIG. 9 illustrates a sectional view of a child-proof locking assembly of the multi-outlet adapter shown in FIG. 1 taken substantially along line 9-9 of FIG. 2;

FIG. 10 illustrates a top view of the multi-outlet adapter shown in FIG. 1 with the door in a closed position;

FIG. 11 illustrates a bottom view of the multi-outlet adapter shown in FIG. 1 with the door in a closed position;

FIG. 12 illustrates a front view of the multi-outlet adapter shown in FIG. 1 with the door in a closed position;

FIG. 13 illustrates a perspective view of a multi-outlet adapter with safety cover having three receptacles and a vertically swinging door shown in an open position, according to a second embodiment of the present invention;

FIG. 14 illustrates a perspective view of the multi-outlet adapter shown in FIG. 13 with the door in a closed position.

FIG. 15 illustrates a back view of the multi-outlet adapter shown in FIG. 13 with the door in a closed position;

FIG. 16 illustrates a left side view of the multi-outlet adapter shown in FIG. 13;

FIG. 17 illustrates a left side view of the multi-outlet adapter shown in FIG. 13 with the door in a closed position;

FIG. 18 illustrates a top view of the multi-outlet adapter shown in FIG. 13 with the door in a closed position;

FIG. 19 illustrates a bottom view of the multi-outlet adapter shown in FIG. 13 with the door in a closed position; and

FIG. 20 illustrates a front view of the multi-outlet adapter shown in FIG. 13 with the door in a closed position.

### DETAILED DESCRIPTION OF THE INVENTION

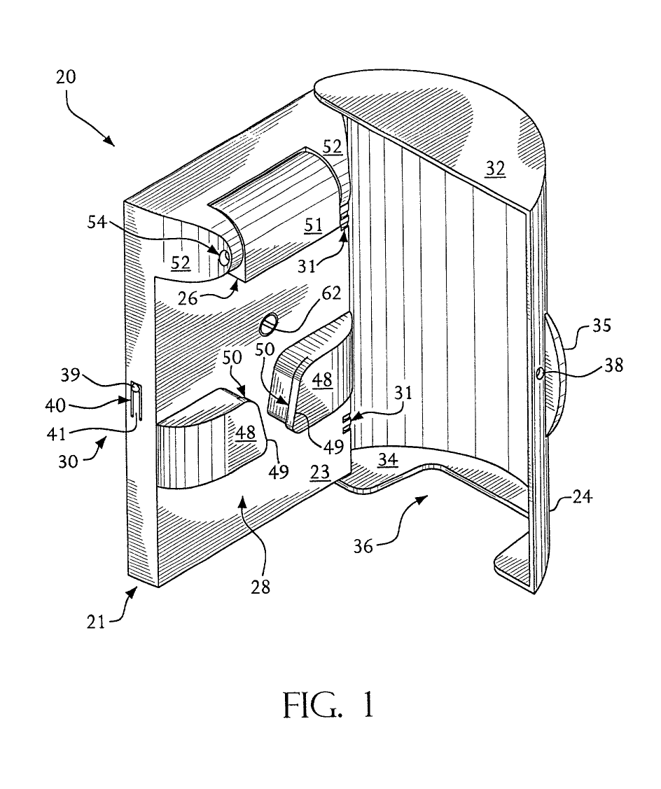

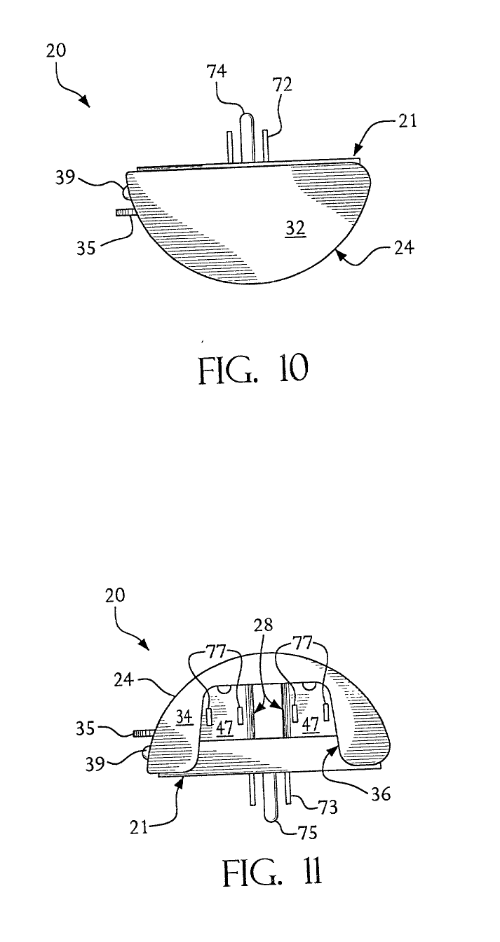

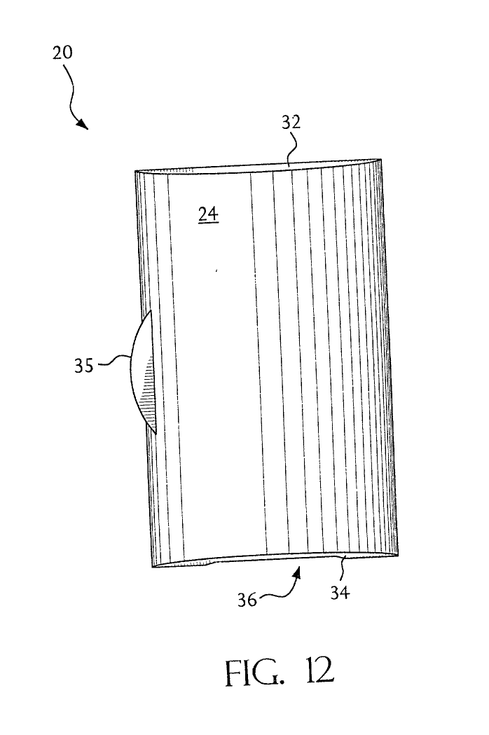

Referring now to the drawings, wherein like numerals indicate like elements, there is shown in FIGS. 1 through 12 a multi-outlet adapter with safety cover 20. The multi-outlet adapter 20 mounts on and is electrically connected to any standard wall outlet. The adapter 20 converts the two receptacles of a standard wall outlet into four receptacles while providing a horizontally swinging hinged door that conceals all four receptacles, whether or not any one or all four receptacles are in use (i.e. have electrical accessory plugs connected thereto).

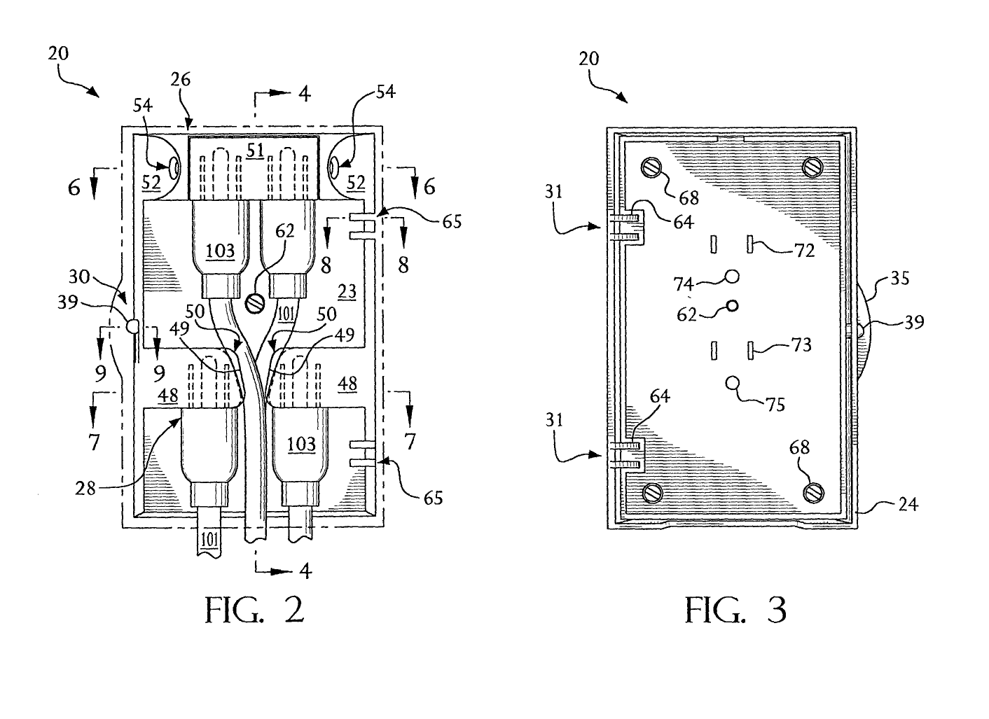

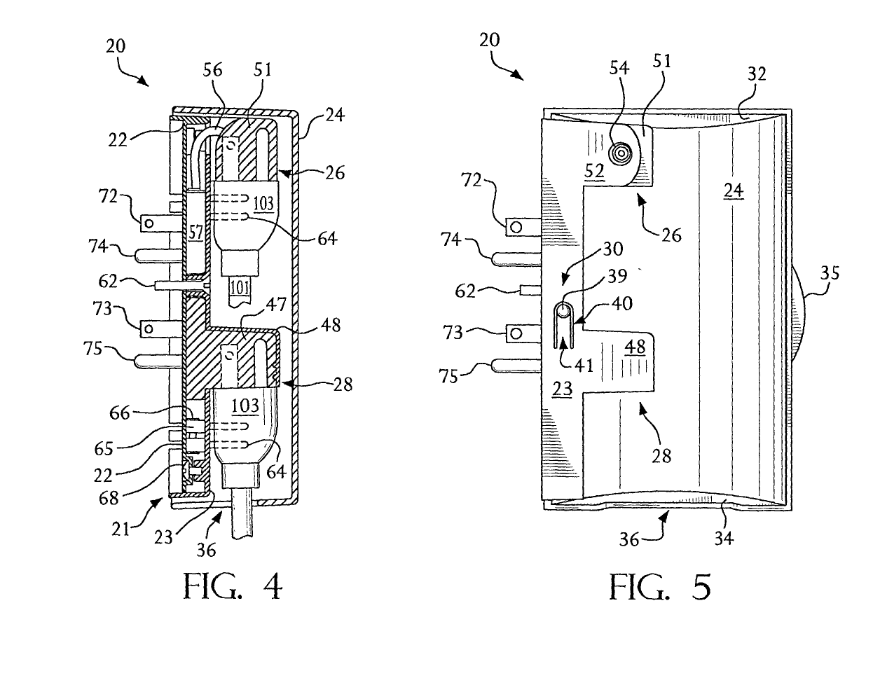

Referring to FIGS. 1 and 2, the multi-outlet adapter 20 includes a backplate 21, a door 24, two upper receptacles 26, two lower receptacles 28, and a child-proof locking assembly 30. The backplate 21 is a two piece assembly having a backplate frame 22 and a backplate cover 23. The backplate frame 22 and the backplate cover 23 are connected by attachment screws 68 (as shown in section in FIG. 4).

The door 24 opens horizontally and is connected by hinges 31 to the back plate 21. The door 24 includes a top 32, a bottom 34, a tab 35, and a hole 38. The tab 35 operates as a handle to open and close the door 24. The bottom 34 of the door 24 includes an indentation 36. The indentation 36 is shaped to permit accessory cords 101 to exit the multi-outlet adapter 20 when the door 24 is closed while preventing child intrusion through the bottom 34 of the door 24. The indentation 36 also serves to organize and secure accessory cords 101 within the multi-outlet adapter 20, permitting easy closing of the door 24 while accessories are plugged into the multi-outlet adapter 20. The multi-outlet adapter 20 permits opening and closing of the door 24 whether any or all four receptacles have an accessory plug 103 connected thereto.

The child-proof locking assembly 30 (also detailed in FIG. 9) includes a button 39 connected by a flexible attachment member 41 to the backplate cover 23. The button 39 and the flexible attachment member 41 reside within a perforation 40 in the backplate cover 23. Upon closing the door 24, the hole 38 in the door 24 accepts the button 39, thereby preventing child-intrusion into the multi-outlet adapter 20.

The two lower receptacles 28 are fixed, each residing within an individual lower receptacle housing 48 integrally formed in backplate cover 23. The lower receptacle housings 48 include a front contour that follows the contour of the door 24 (as shown in section in FIG. 7). The contour of the lower receptacle housings 48 and the door 24 efficiently minimize a distance the door 24 must extend from the wall outlet to allow electrical use of the lower receptacles 28 with the door 24 closed.

Each lower receptacle housing 48 also includes a tapered edge 49 and a lip 50 (also shown in section in FIG. 7). The top to bottom inner tapered edge 49 of each lower receptacle housing 48 makes progressively narrower a space between the two lower receptacle housings 48. The tapered edges 49 and the lips 50 provide a means to secure and organize accessory cords 101 electrically connected to the two upper receptacles 26. The accessory cords 101 connected to the two upper receptacles 26 are draped between the two lower receptacle housings 48, are tucked behind the lips 50 (as shown in FIG. 2), and are draped through the indentation 36 in the bottom 34 of the door 24 when the door 24 is closed. Accessory cords 101 connected to the lower receptacles 28 simply drape through the indentation 36 in the bottom 34 of the door 24 when the door 24 is closed (as shown in FIGS. 2 and 4).

The two upper receptacles 26 reside within a rotatable upper receptacle body 51. Each end of the rotatable body 51 is rotatably connected by a pin 54 to a mounting flange 52. Each mounting flange 52 is fixedly connected to and integrally formed with the backplate cover 23. The pins 54 allow at least 900 rotation of the rotatable body 51 about an axis defined by a line through and adjoining the two pins 54. The rotation of the rotatable body 51 relative to the backplate cover 23 allows easy electrical connection of accessory plugs 103 to the upper receptacles 26. First, the body 51 is rotated 90° away from the closely located lower receptacle housings 48 so that prong openings 76 in the upper receptacles 26 are perpendicular to prong openings 77 in the lower receptacles 28. Accessory plugs 103 are inserted into the upper receptacles 26. The upper receptacle body 51 is then rotated back 90° so that the prong openings 76 in the upper receptacles 26 face downward, parallel to prong openings 77 in the lower receptacles 28 and accessory cords 101 drape parallel to the backplate cover 23 (as shown in FIGS. 2 and 4) allowing closure of the door 24. The rotatable design of the upper receptacles 26 allow four receptacles to be located in close proximity in one device having minimal size and pleasant aesthetic appearance while also providing a lockable door capable of concealing the four receptacles while in use.

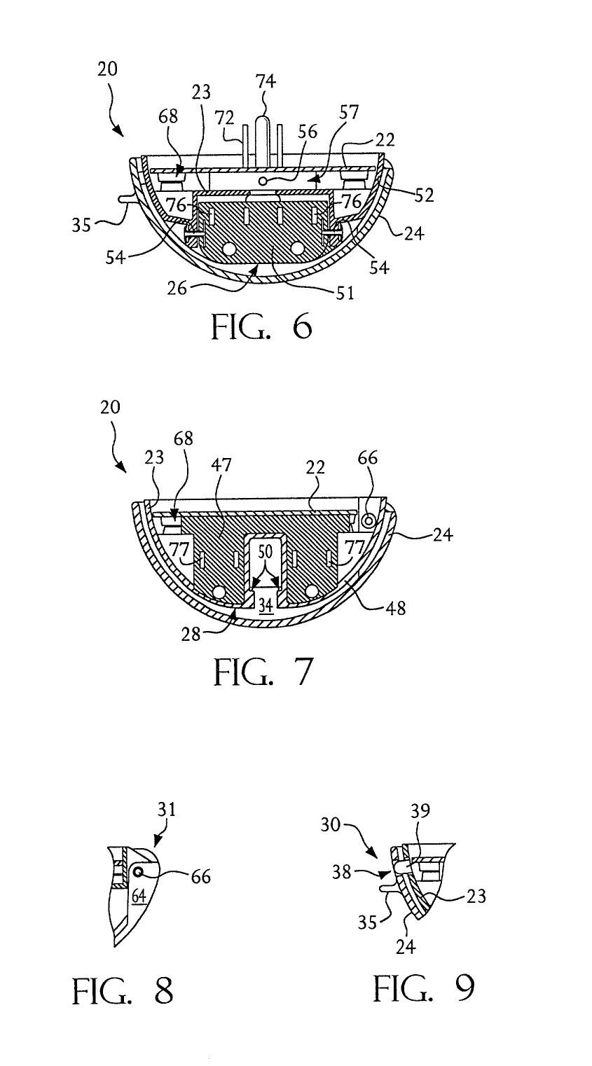

The mounting flanges 52 include a front contour that follows the contour of the door 24 (as shown in section in FIG. 6). The contour of the mounting flanges 52 and the door 24, together with the rotatable configuration of the upper receptacle body 51, efficiently minimize a distance the door 24 must extend from the wall outlet to allow electrical use of the upper receptacles 26 with the door 24 closed. The design minimizes an overall, three-dimensional size and area of the multi-outlet adapter 20 while providing use of four, concealed and child-proof receptacles.

Referring now to FIGS. 3, 4 and 5, the multi-outlet adapter 20 is mounted on and is electrically connected to any standard wall outlet (not shown). The multi-outlet adapter 20 can be installed whether or not a faceplate (not shown) exists over the wall outlet. Contact prongs 72,73 and ground prongs 74,75 are inserted into the prong openings of the wall outlet. Mounting screw 62 is then inserted through a mounting hole in the faceplate and is threadably connected to a faceplate mounting hole in the wall outlet, thereby securing the multi-outlet adapter 20 to the wall outlet.

A flexible cord 56 connects the upper receptacle body 51 to a contact pad 57 (shown in FIG. 4) to facilitate the rotatable configuration of the upper receptacles 26. The contact pad 57 provides electrical connectivity between the flexible cord 56 and the contact prongs 72 and the ground prong 74. Due to the fixed nature of the lower receptacles 28, a one-piece lower receptacle body 47 (as shown in FIGS. 4 & 7) provides electrical connectivity between the lower receptacles 28 and the respective contact prongs 72 and ground prong 74.

FIGS. 4 and 6 illustrate the arrangement of the back plate frame 22 and the back plate cover 23. Four attachment screws 68 (also shown in FIG. 3) threadably secure the back plate cover 23 to the back plate frame 22. The interconnection of the back plate cover 23 and the back plate frame 22 secure the lower receptacle body 47 and the contact pad 57. The mounting screw 62 is threadably connected to the back plate frame 22 and the back plate cover 23.

The door 24 is movably attached to the back plate cover 23 by two hinges 31. Each hinge 31 includes two recesses 65 in the back plate cover 23 (as shown in FIG. 2), two plates 64 integral to the door 24 and a hinge pin 66 (as shown in FIGS. 4 and 8). The two plates 64 are inserted into respective recesses 65 and the hinge pin 66 inserted through holes (not shown) in the plate and recess combination (as shown in FIG. 4).

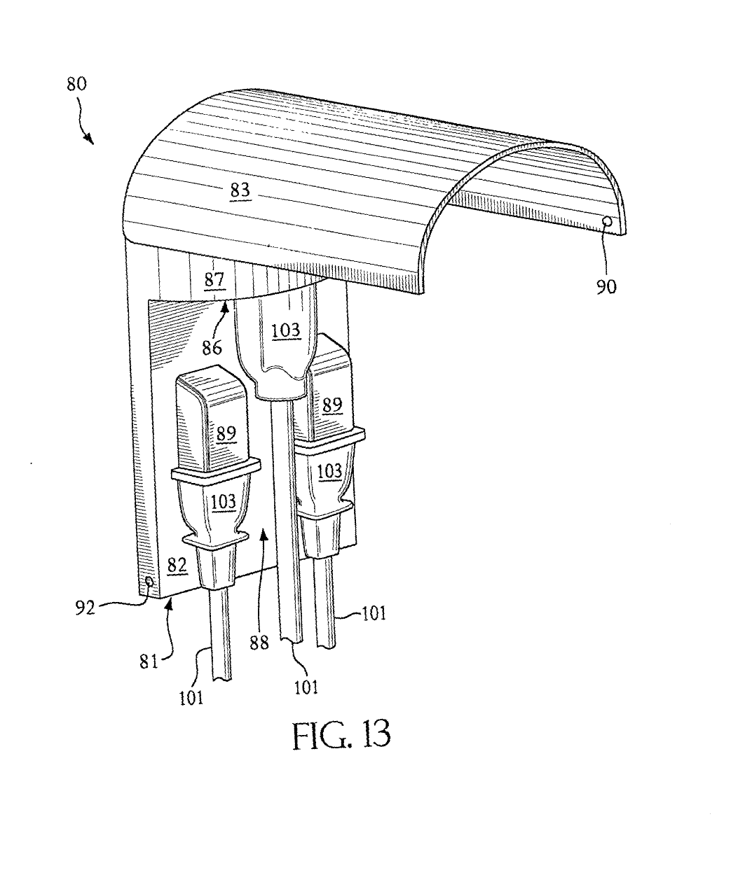

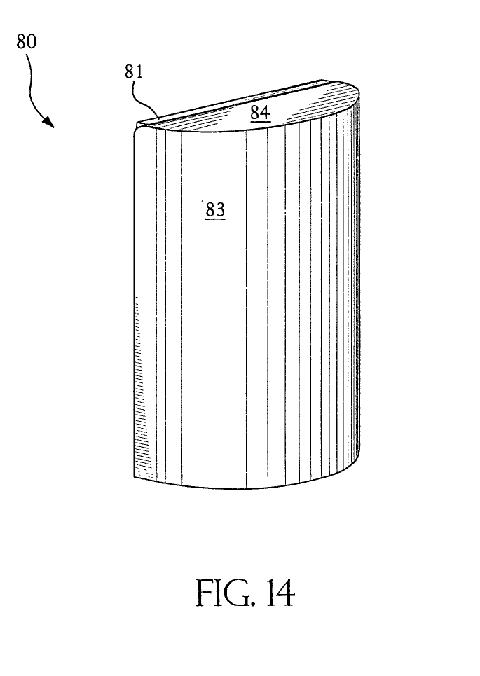

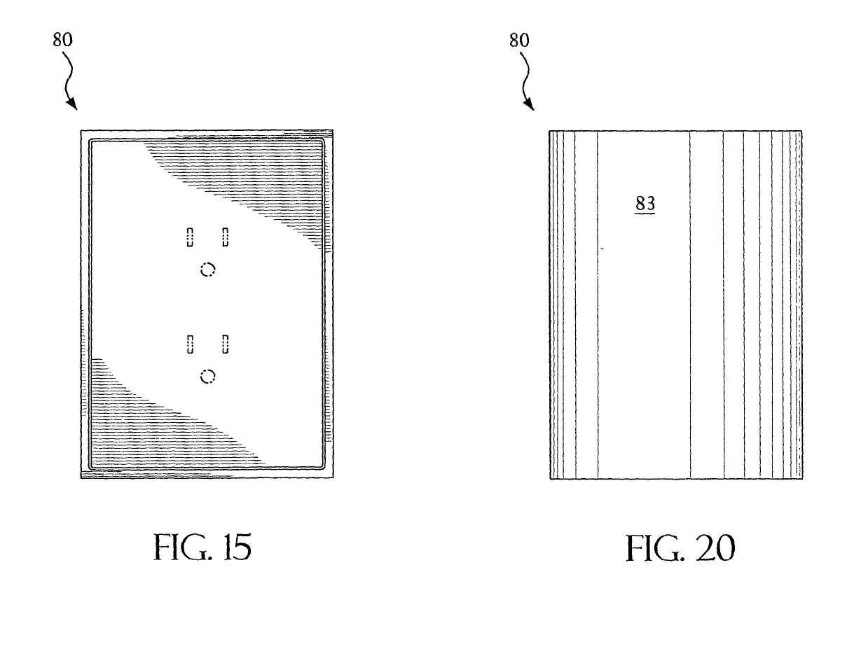

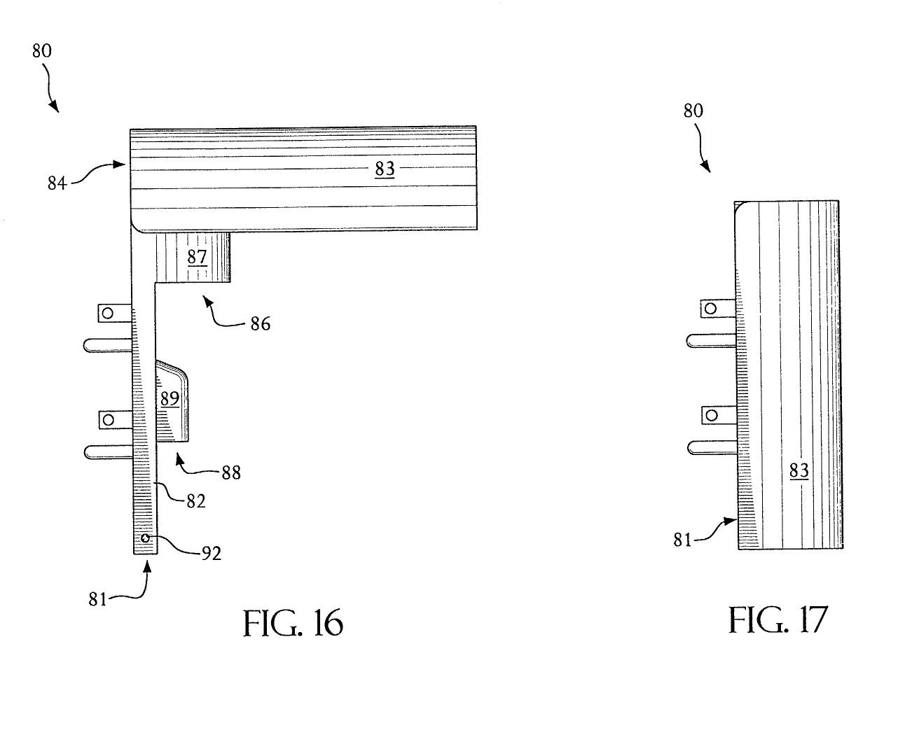

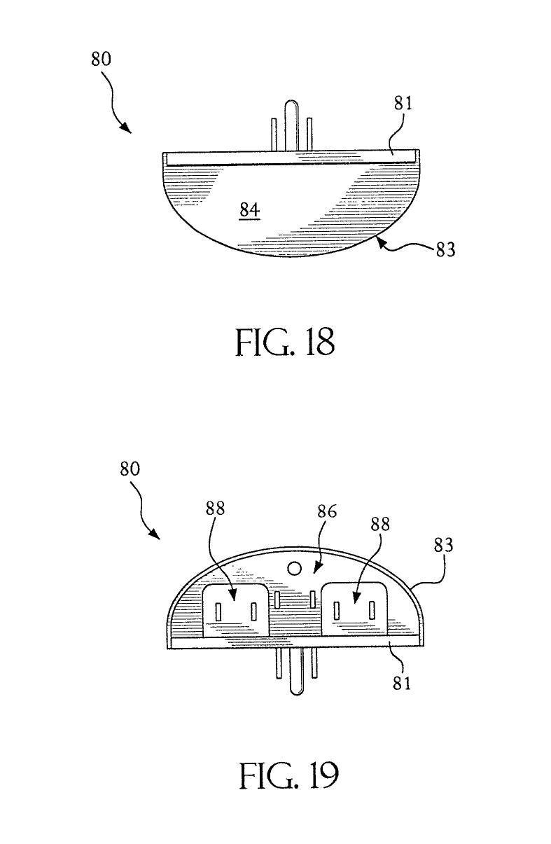

FIGS. 13 through 20 illustrate an alternative embodiment multi-outlet adapter with safety cover 80 having three receptacles and a vertically swinging hinged door capable of concealing the three receptacles while in use. Construction of the three receptacle adapter 80 is generally similar to that of the four receptacle adapter 20, the alternative embodiment shown in FIGS. 13 through 20 illustrating further features which could be alternatively incorporated into either or additional embodiments.

Referring to FIGS. 13 through 20 generally, and particularly to FIG. 13, the three receptacle multi-outlet adapter 80 includes a back plate 81, a door 83, one upper receptacle 86 and two lower receptacles 88. The back plate 81 is a two piece assembly having a back plate frame (not shown) and a back plate cover 82.

The door 83 swings open vertically and includes a top 84, an open bottom and two detents 90 on respective lower inner corners. Each detent 90 is received by a respective indentation 92 located on a lower outer edge of the back plate cover 82 to secure the door in a closed position.

The two lower receptacles 88 are fixed, each residing within an individual lower receptacle housing 89 integrally formed in the back plate cover 82. Each lower receptacle 88 is narrow in depth, not providing ground prong access (as shown in FIG. 19). The narrow depth of the lower receptacles 88 and the convex contour of the door 83 efficiently minimize a distant the door 83 must extend from the wall outlet to allow electrical use of the lower receptacles 88 with the door 83 closed.

The one upper receptacle 86 resides within a fixed upper receptacle housing 87 integrally formed in back plate cover 82. The one upper receptacle 86 is centrally located in a bottom of the upper receptacle housing 87 providing access for a ground prong within the sleek contour of the door 83. Accessory plugs 103 connected to the three receptacle adapter 80 have accessory cords 101 that freely drape downward (as shown in FIG. 13) and out of the open bottom of the door 83 when the door 83 is closed to conceal the receptacles. It is to be understood that the individual features of the three receptacle adapter 80 and the four receptacle adapter 20 (e.g. vertical vs. horizontal door, single vs. double rotatable upper receptacles, narrow depth vs. contoured and tapered lower receptacles) could be individually selected to arrive at numerous alternative embodiments of the present invention.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. A multi-outlet adapter device with safety cover, comprising:
a. a back plate adaptable to a wall outlet for mounting the device on and electrically connecting the device to the wall outlet;
b. at least one receptacle connected to the back plate; and
c. a door movably connected to the back plate, the door movable between an open position exposing the at least one receptacle and a closed position concealing the at least one receptacle.

2. The device of claim 1, wherein the back plate includes a screw extending through and rotatably connected thereto for securing the device to the wall outlet.

3. The device of claim 1, wherein the door is slidably attached to the back plate, the door permitting use of the at least one receptacle while concealing the at least one receptacle.

4. The device of claim 3, wherein the door includes an indentation, the indentation securing cords of accessories connected to the at least one receptacle.

5. The device of claim 1, wherein the door is hinged to the back plate, the door permitting use of the at least one receptacle while concealing the at least one receptacle.

6. The device of claim 5, wherein the door includes an indentation, the indentation securing cords of accessories connected to the at least one receptacle.

7. The device of claim 1, further comprising a childproof locking assembly.

8. The device of claim 7, wherein the childproof locking assembly includes:
a. a button flexibly attached to the back plate and integral thereto, the button residing within a perforation in the back plate; and
b. a hole in the door aligned to receive the button upon closing of the door, whereby reception of the button by the hole in the door prevents reopening of the door without removing the button from the hole in the door.

9. The device of claim 1, wherein the back plate includes clips to organize and secure cords of plugs connected to the at least one receptacle.

10. The device of claim 1, wherein the safety cover includes a paintable exterior surface allowing a user to apply a customized finish to the device.

11. The device of claim 1, wherein a portion of an exterior of the safety cover is luminous, allowing the device to additionally function as a night light.

12. The device of claim 1, wherein the at least one receptacle is fixedly connected to the back plate, the at least one receptacle having prong openings perpendicularly aligned in relation to prong openings of the wall outlet, the perpendicular alignment minimizing a distance the door extends from the back plate when closed, while allowing use of the at least one receptacle while the door is closed.

13. The device of claim 1, wherein the at least one receptacle is pivotally connected to the back plate, the pivotal connection allowing insertion of an electrical plug into the at least one receptacle while prong openings of the at least one receptacle are aligned parallel to prong openings of the wall outlet and allowing concealment of the at least one receptacle while the prong openings of the at least one receptacle are aligned perpendicular to the prong openings of the wall outlet.

14. The device of claim 13, wherein the pivotal connection includes:
a. two mounting flanges connected to the back plate;
b. a housing having at least one receptacle; and
c. at least one pin rotatably connecting the mounting flanges to the housing.

15. The device of claim 1, wherein the device contains four receptacles, the device including:
a. two upper receptacles pivotally connected to the back plate, the pivotal connection allowing insertion of an electrical plug into either of the two upper receptacles while prong openings in the two upper receptacles are aligned parallel to prong openings in the wall outlet and allowing concealment of the two upper receptacles while the prong openings of the two upper receptacles are aligned perpendicular to the prong openings of the wall outlet; and
b. two lower receptacles fixedly connected to the back plate, the two lower receptacles having prong openings perpendicularly aligned in relation to the prong openings of the wall outlet.

16. The device of claim 15, wherein the pivotal connection includes:
a. two mounting flanges connected to the back plate;
b. a housing retaining the two upper receptacles; and
c. at least one pin rotatably connecting the mounting flanges to the housing.

17. The device of claim 15, wherein the two lower receptacles each reside in an individual fixed housing, the two fixed housings providing therebetween a means to organize and secure cords of accessories connected to the upper receptacles.

18. The device of claim 15, wherein the two lower receptacles each reside in an individual fixed housing, the two fixed housings each including a lip and an edge tapered from top to bottom, the tapered edges making progressively narrower at the bottom a space between the two fixed housings, the tapered edges and the lips securing and organizing cords of accessories connected to the upper receptacles.

19. The device of claim 15, wherein the back plate includes a screw extending through and rotatably connected thereto for securing the device to the wall outlet.

20. The device of claim 15, wherein the door includes an indentation, the indentation securing cords of accessories connected to the at least one receptacle.

21. The device of claim 15, further comprising a childproof locking assembly.

22. The device of claim 21, wherein the childproof locking assembly includes:
a. a button flexibly attached to the back plate and integral thereto, the button residing within a perforation in the back plate; and
b. a hole in the door aligned to receive the button upon closing of the door, whereby reception of the button by the hole in the door prevents reopening of the door without removing the button from the hole in the door.

23. The device of claim 15, wherein the back plate includes clips to organize and secure cords of plugs connected to the at least one receptacle.

24. The device of claim 15, wherein the safety cover includes a paintable exterior surface allowing a user to apply a customized finish to the device.

25. The device of claim 15, wherein a portion of an exterior of the safety cover is luminous, allowing the device to additionally function as a night light.

26. A multi-outlet adapter device with safety cover, comprising:
a. a back plate adaptable to a wall outlet for mounting the device on and electrically connecting the device to the wall outlet;
b. at least one receptacle connected to the back plate; and
c. a door movably connected to the back plate, the door movable between an open position exposing the at least one receptacle and a closed position concealing the at least one receptacle, the closed position permitting use of the at least one receptacle while concealing the at least one receptacle.
